(19) United States
(12) Patent Application Publication
(10) Pub. No.: US 2025/0132387 A1
(43) Pub. Date: Apr. 24, 2025

(54) MITIGATING PASSIVATION OF METAL ELECTRODES

(71) Applicant: FORM ENERGY, INC., Somerville, MA (US)

(72) Inventors: Hannah BATES, Cambridge, MA (US); Jeffrey POIRIER, Quincy, MA (US); Marc SYVERTSEN, Madison, WI (US); Annelise Christine THOMPSON, Somerville, MA (US); Jocelyn Marie NEWHOUSE, Somerville, MA (US); Ke HUANG, Somerville, MA (US); Zachariah NORMAN, Lincoln, MA (US); Caitlin BENTLEY, Wilmington, MA (US); Johanna BARBOUR, Everett, MA (US)

(21) Appl. No.: 18/922,381

(22) Filed: Oct. 21, 2024

Related U.S. Application Data
(60) Provisional application No. 63/591,625, filed on Oct. 19, 2023.
(60) Provisional application No. 63/591,606, filed on Oct. 19, 2023.
(60) Provisional application No. 63/607,498, filed on Dec. 7, 2023.

(51) Int. Cl. H01M 10/0565

(52) U.S. Cl. CPC H01M 10/0565; H01M 2300/0085

(57) ABSTRACT

According to one aspect, an electrochemical cell may include a first electrode including a metal-containing active material, a second electrode, and an electrolyte in ionic communication between the first electrode and the second electrode, the electrolyte including a gel and an additive, the gel including a polymer network and a liquid medium, the polymer network carried in the liquid medium, the additive suspended in the gel and accumulable at the metal-containing active material of the first electrode.

### CROSS-REFERENCE TO RELATED APPLICATIONS

This application claims priority to U.S. Provisional App. 63/591,625, filed Oct. 19, 2023, to U.S. Provisional App. 63/591,606, filed Oct. 19, 2023, and to U.S. Provisional App. 63/607,498, filed Dec. 7, 2023, with the entire contents of each of these applications hereby incorporated herein by reference.

### BACKGROUND

Energy storage technologies are playing an increasingly important role in electric power grids. These energy storage assets provide smoothing to better match generation and demand on a grid. The services performed by energy storage devices are beneficial to electric power grids across multiple time scales, from milliseconds to years. Today, energy storage technologies exist that can support timescales from milliseconds to hours, but there is a need for long and ultralong (collectively, >8h) energy storage systems. Of benefit are potentially low-cost rechargeable battery chemistries that can enable long duration large scale energy storage.

### SUMMARY

According to one aspect, an electrochemical cell may include a first electrode including a metal-containing active material, a second electrode, and an electrolyte in ionic communication between the first electrode and the second electrode, the electrolyte including a gel and an additive, the gel including a polymer network and a liquid medium, the polymer network carried in the liquid medium, the additive suspended in the gel and accumulable at the metal-containing active material of the first electrode.

According to another aspect, an electrochemical cell may include a first electrode including an iron-containing active material, a second electrode, and an alkaline electrolyte in ionic communication between the first electrode and the second electrode, the alkaline electrolyte in contact with one or more surfaces of the iron-containing active material of the first electrode, the alkaline electrolyte including an additive and, at least on discharge of the electrochemical cell, the additive including an iron-binding ligand formable into a coordination complex with one or more dissolution products of the first electrode on discharge of the electrochemical cell.

### DESCRIPTION OF THE DRAWINGS

FIG. 1A is a schematic representation of an electrochemical cell.

FIG. 1B is a schematic representation of a rechargeable battery.

FIG. 2 is a schematic representation of an electrochemical cell including a first electrode, a second electrode, and an electrolyte, with the first electrode including a metal-containing active material, the electrolyte in ionic communication between the first electrode and the second electrode, and the electrolyte including a gel suspended an additive.

FIG. 3 is a graph of experimentally determined total discharge capacity (mAh/g) over a number of cycles for PEG electrochemical cells having electrolytes with varying levels of gel.

FIG. 4 is a graph of experimentally determined total discharge capacity (mAh/g) over a number of cycles for PEG electrochemical cells having electrolytes with an organic additive and varying levels of gel.

FIG. 5 is an experimentally determined graph of electrochemical cell voltage (versus reversible hydrogen electrode) as a function of capacity of a control electrochemical cell and of an electrochemical cell including an electrolyte having an organic additive suspended in a gel.

FIG. 6 is an experimentally determined cyclic voltammetry graph of iron foil testing for a system including an electrolyte with including stannate and a gel without an additive, a system including an electrolyte with an organic additive suspended in gel and without stannate, and a system including an electrolyte with stannate and an organic additive suspended in stannate.

FIG. 7 is an experimentally determined graph of electrochemical cell voltage as a function of capacity comparing electrochemical cells including electrolytes with different concentrations of citric acid.

FIG. 8 is an experimentally determined graph of Coulombic efficiency as a function of number of cycles for a baseline electrochemical cell without an additive and a test electrochemical cell having an electrolyte including succinic acid.

FIG. 9 is an experimentally determined graph of electrochemical cell voltage as a function of capacity comparing electrochemical cells including electrolytes with different concentrations of succinic acid.

FIG. 10 is an experimentally determined graph of ex situ hydrogen screening for citric acid, malic acid, sodium 3-hydroxybutyrate, and succinic acid.

Like reference symbols in the various drawings indicate like elements.

### DETAILED DESCRIPTION

Embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims. The following description of the embodiments of the disclosure is not intended to limit the disclosure to these embodiments but rather to enable a person skilled in the art to make and use this disclosure. Unless otherwise noted, the accompanying drawings are not drawn to scale.

As used herein unless specified otherwise, the recitation of ranges of values herein is merely intended to serve as a shorthand method of referring individually to each separate value falling within the range. Unless otherwise indicated herein, each individual value within a range is incorporated into the specification as if it were individually recited herein.

The following examples are provided to illustrate various embodiments of the present systems and methods of the present disclosure. These examples are for illustrative purposes, may be prophetic, and should not be viewed as limiting, and do not otherwise limit the scope of the present disclosure.

The various embodiments of systems, equipment, techniques, methods, activities, and operations set forth in this specification may be used for various other activities and in other fields in addition to those set forth herein. Additionally, these embodiments, for example, may be used with other equipment or activities that may be developed in the future and with existing equipment or activities which may be modified, in-part, based on the teachings of this specification. Further, the various embodiments and examples set forth in this specification may be used with each other, in whole or in part, and in different and various combinations. Thus, for example, the configurations provided in the various embodiments of this specification may be used with each other. Thus, the configurations provided in the various embodiments of this specification may be used with each other. For example, the components of an embodiment having A, A′ and B and the components of an embodiment having A″, C and D can be used with each other in various combination, e.g., A, C, D, and A. A″ C and D, etc., in accordance with the teaching of this Specification. The scope of protection afforded the present disclosure should not be limited to a particular embodiment, configuration or arrangement that is set forth in a particular embodiment, example, or in an embodiment in a particular figure.

As used herein, unless stated otherwise, room temperature is 25° C. And, standard temperature and pressure is 25° C. and 1 atmosphere. Unless expressly stated otherwise all tests, test results, physical properties, and values that are temperature dependent, pressure dependent, or both, are provided at standard ambient temperature and pressure.

Unless otherwise specified or made clear from the context, all references to mean particle size herein shall be understood to refer to mean particle size on a weight percentage basis. Thus, some references to mean particle size herein may occasionally omit specific mention of “weight percentage basis” for the sake of clarity and readability.

Embodiments of the present disclosure include apparatuses, systems, and methods for long-duration, and ultra-long-duration energy storage. Herein, “long duration” and/or “ultra-long duration” may refer to periods of energy storage of 8 hours or longer, such as periods of energy storage of 8 hours, periods of energy storage ranging from 8 hours to 20 hours, periods of energy storage of 20 hours, periods of energy storage ranging from 20 hours to 24 hours, periods of energy storage of 24 hours, periods of energy storage ranging from 24 hours to a week, periods of energy storage ranging from a week to a year (e.g., such as from several days to several weeks to several months), etc. In other words, “long duration” and/or “ultra-long duration” energy storage devices or systems may refer to energy storage devices or systems that may be configured to store energy over time spans of days, weeks, or seasons. For example, the energy storage devices or systems may be configured to store energy generated by solar cells during the summer months, when sunshine is plentiful and solar power generation exceeds power grid requirements, and discharge the stored energy during the winter months, when sunshine may be insufficient to satisfy power grid requirements.

According to other embodiments, the present invention includes apparatus, systems, and methods for energy storage at shorter durations of less than about 8 hours. For example, the electrochemical cells may be configured to store energy generated by solar cells during the diurnal cycle, where the solar power generation in the middle of the day may exceed power grid requirements, and discharge the stored energy during the evening hours, when the sunshine may be insufficient to satisfy power grid requirements. As another example, said invention may include energy storage used as backup power when the electricity supplied by the power grid is insufficient, for installations including homes, commercial buildings, factories, hospitals, or data centers, where the required discharge duration may vary from a few minutes to several days.

An electrochemical cell, such as a battery, stores electrochemical energy by using a difference in electrochemical potential generating a voltage difference between the positive and negative electrodes. This voltage difference produces an electric current if the electrodes are connected by a conductive element. In a battery, the negative electrode and positive electrode are connected by external and internal resistive elements in series. Generally, the external element conducts electrons, and the internal element (electrolyte) conducts ions. Because a charge imbalance cannot be sustained between the negative electrode and positive electrode, these two flow streams must supply ions and electrons at the same rate. In operation, the electronic current can be used to drive an external device. A rechargeable battery can be recharged by applying an opposing voltage difference that drives an electric current and ionic current flowing in the opposite direction as that of a discharging battery in service.

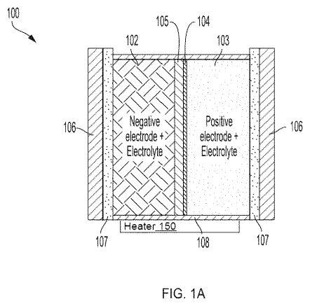

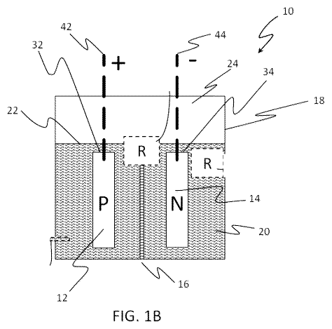

Referring now to FIG. 1A, an electrochemical cell 100 (e.g., a battery) may include a negative electrode 102 separated from a positive electrode 103 by a separator 104. The separator 104 may be supported, for example, by a mesh 105 (e.g., a polypropylene mesh) and a frame 108 (e.g., polyethylene or polypropylene) of the electrochemical cell 100. Current collectors 107 may be associated with respective ones of the negative electrode 102 and positive electrode 103 and supported by backing plates 106 (e.g., polyethylene or polypropylene backing plates). In some embodiments, the temperature of the electrochemical cell 100, may be controlled, such as by insulation around the electrochemical cell 100 and/or by a heater 150. For example, the heater 150 may raise the temperature of the electrochemical cell 100 and/or specific components of the cell, such as an electrolyte infiltrated in the negative electrode 102 and the positive electrode 103. The electrolyte may be an aqueous solution. In certain embodiments the electrolyte may be an alkaline solution (pH>10). In certain embodiments, the electrolyte may be a near-neutral solution (10>pH>4).

The electrochemical cell 100 is merely an example of one electrochemical cell configuration according to various embodiments and is not intended to be limiting. Other configurations, such as electrochemical cells with different type meshes and/or without the mesh 105, electrochemical cells with different type frames and/or without the frame 108, electrochemical cells with different type current collectors and/or without the current collectors 107, electrochemical cells with reservoir structures, electrochemical cells with different type backing plates and/or without the backing plates 106, electrochemical cells with different type insulation and/or without insulation, and/or electrochemical cells with different type heaters and/or without the heater 150, may be substituted for the example configuration of the electrochemical cell 100 shown in FIG. 1A and other configurations are in accordance with the various embodiments.

In some embodiments, a plurality of electrochemical cells 100 in FIG. 1A may be connected electrically in series to form a stack. In certain other embodiments, a plurality of electrochemical cells 100 may be connected electrically in parallel. In certain other embodiments, the electrochemical cells 100 are connected in a mixed series-parallel electrical configuration to achieve a favorable combination of delivered current and voltage.

Referring now to FIG. 1B, a rechargeable battery 10 may include a positive electrode 12, a negative electrode 14, and a separator 16 within a container 18 filled with electrolyte 20 to a level 22 at least as high as the respective tops 32, 34 of the electrodes 12, 14. The space above the level 22 of the electrolyte 20 may be referred to as the headspace 24. The positive electrode 12 may be electrically connected to a positive terminal 42 of the rechargeable battery 10 and may contain active material that may undergo reduction reactions during discharging and oxidation reactions during charging. The negative electrode 14 may be electrically connected to a negative terminal 44 of the rechargeable battery 10 and may contain active material that may undergo oxidation reactions during discharging and reduction reactions during charging of the rechargeable battery 10. The rechargeable battery 10 in FIG. 1B is merely an example of one electrochemical cell according to various embodiments and is not intended to be limiting.

In various embodiments, the electrolyte 20 may be an aqueous or non-aqueous alkaline, neutral, or acidic solution. For example, the electrolyte solution may contain potassium hydroxide (KOH), sodium hydroxide (NaOH), lithium hydroxide (LiOH) or combinations of these.

In some embodiments, a battery 10 may include a separator 16 that allows transfer of ions between the electrodes 12, 14 via the electrolyte. In some embodiments, a separator may be chosen based on an ability to allow selective transfer of desired molecules or materials while substantially limiting or preventing transfer of undesired molecules or materials. For example, some separator membranes are ion-selective and allow the transfer of negative (or positive) ions while substantially preventing transfer of positive (or negative) ions. In other examples, separator materials may be chosen based on an ability to allow or prevent the cross-over of gas bubbles from one side (associated with one electrode) to the opposite side (associated with the counter-electrode).

In various embodiments, the container 18 may be made of any suitable materials and construction capable of containing the electrolyte, electrodes, and at least a minimum amount of gas pressure. For example, the container 18 may be made of metals, plastics, composite materials, or others. In some embodiments, the battery container 18 may be sealed so as to prevent the escape of any gases generated during operation of the battery.

In some embodiments, the battery container 18 may include a pressure relief valve to allow release of gases when a gas pressure within the battery container 18 exceeds a pre-determined threshold.

While the electrodes 12, 14 are shown substantially spaced apart in the figures, in some embodiments the electrodes may be very close to one another or even compressed against one another with a separator 16 in between. Furthermore, although the figures may illustrate a single positive electrode 12 and a single negative electrode 14, battery systems within the scope of the present disclosure may also include two or more positive electrodes 12 and/or two or more negative electrodes 14. For example, the positive electrode 12 may include an oxygen reduction reaction (ORR) electrode, an oxygen evolution reaction (OER) electrode, or a combination thereof.

Referring now to FIGS. 1A and 1B, it shall be generally understood that the negative electrode 102 of the electrochemical cell 100 and/or the negative electrode 14 of the rechargeable battery 10 may include metal or metal oxides such as iron, zinc, cadmium, or other metals and/or oxides or hydroxides of these or other metals, unless otherwise specified or made clear from the context. Further, it shall be generally understood that the negative electrode 102 of the electrochemical cell 100 and the negative electrode 14 of the rechargeable battery 10 have similar or identical features, unless otherwise indicated or made clear from the context and, for the sake of efficient description, these are not described separately for each negative electrode.

### Electrolyte Including Additive Suspended in Gel

Having described certain aspects of the electrochemical cell 100 and the battery 10, attention is now directed to the description of certain organic additives that may be added to the electrochemical cell 100 and/or to the rechargeable battery 10 to improve performance of the electrochemical cell 100 and/or the rechargeable battery 10.

Hydrogen evolution is a key side reaction in an iron-air battery that causes inefficiencies while charging and losses during rest. In an aqueous, alkaline electrolyte, hydrogen evolution happens at similar potentials to iron reduction, decreasing the achievable Coulombic efficiency. At rest, metallic iron forms a galvanic couple with water permitting the evolution of hydrogen gas, concomitant with oxidation of iron. Surface active compounds in metal electrodes may protect a surface of the metal electrode from corrosion reactions (such as surface oxidation) and/or suppress the hydrogen evolution reaction (HER) by adsorbing on the surface. A variety of functional groups may achieve a balance of properties between adsorption to prevent or reduce HER when on rest and relaxation from the metal electrode surface to reduce the likelihood of significantly impeding discharge reactions. However, materials capable of balancing these considerations are often of very low solubility in concentrated alkaline solutions of electrolytes.

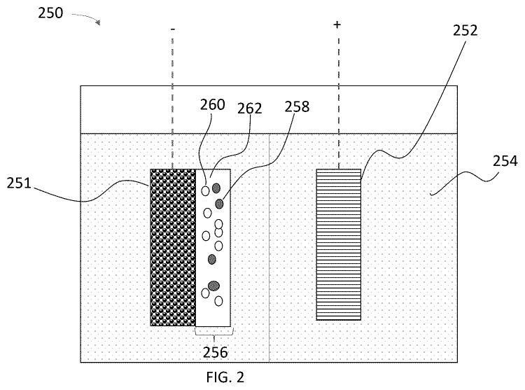

Referring now to FIG. 2, an electrochemical cell 250 may include a first electrode 251, a second electrode 252 (also referred to herein as a positive electrode), and an electrolyte 254. The first electrode 251 may be any one or more of the various different negative electrodes described herein and, in particular, may include a metal-containing active material (e.g., iron). The second electrode 252 may be any one or more of the various different positive electrodes described herein and, thus, may be an air electrode. In certain instances, the second electrode 252 may include an oxygen reduction (ORR) electrode, an oxygen evolution reaction (OER) electrode, or a combination thereof. The electrolyte 254 may be in ionic communication between the first electrode 251 and the second electrode 252. Further, or instead, the electrolyte 254 may include a gel 256 and an additive 258. The gel 256 may include a polymer network 260 and a liquid medium 262, with the polymer network 260 carried in the liquid medium 262. The gel 256 may be in contact with the first electrode 251 and, in some instances, with the second electrode 252. The additive 258 may be suspended in the gel 256 and accumulable at the metal-containing active material of the first electrode 251. As compared to electrolytes without an additive suspended in a gel, the additive 258 suspended in the gel and accumulable at the metal-containing active material of the first electrode 251 may facilitate using low-solubility materials (e.g., one or more organic molecules) as the additive 258 to balance between adsorption to prevent or reduce HER when the electrochemical cell 250 is on rest and relaxation from a surface of the metal-containing active material of the first electrode 251 to reduce the likelihood of significantly impeding discharge reactions. That is, while low-solubility materials would otherwise precipitate out of an electrolyte, the additive 258 suspended in the gel 256 may remain localized at a surface of the metal-containing active material of the first electrode 251. Further, or instead, as compared to an electrolyte without an additive suspended in a gel, suspension of the additive 258 in the gel 256 may facilitate protecting a surface of a metal-containing active material from corrosion and/or may suppress hydrogen evolution reaction (HER). Further, or instead, as compared to an electrolyte without an additive suspended in a gel, suspending the additive 258 in the gel 256 may modify the discharge product to reduce the likelihood of overpassivation and improve charge acceptance of the first electrode 251.

As used herein, unless otherwise specified or made clear from the context, the term “accumulable” shall be understood to include adhering more to the metal-containing active material 254 than staying in the electrolyte 254. For example, an additive with a partition coefficient (metal-containing active material/electrolyte) of greater than 10 may be accumulable on the metal-containing active material. In certain implementations, determining whether an additive is accumulable on the metal-containing active material may include measuring competitive binding. For example, particles of the metal-containing active material may be soaked in the electrolyte 254, and the amount of the additive remaining in the gel 256 of the electrolyte 254 may be measured (via characterization methods including inductively coupled plasma mass spectrometry (ICP-MS), gas chromatography-mass spectrometry (GC-MS), and/or liquid chromatography-mass spectrometry (LC-MS) after soaking. Further, or instead, determining whether an additive is accumulable on the metal-containing active material may include measuring as binding to metal. For example, particles of the metal-containing active material may be soaked in a solution containing only the additive 258, and the amount of the additive 258 on the particles may be measured (e.g., using x-ray photoelectron spectroscopy (XPS), Fourier transform infrared spectroscopy (FTIR), and/or Raman spectroscopy). Still further, or instead, determining whether an additive is accumulable on the metal-containing active material may be measured as binding on the electrode using electrochemical quartz microbalance (the EQCM). The EQCM is coated with the metal-containing active material of interest (e.g., via sputtering or chemical vapor deposition). The EQCM is the working electrode of a three-electrode cell with a counter electrode (e.g. Ni, Pt mesh), and a reference electrode (e.g. Hg/HgO for alkaline solutions, Ag/AgCl for neutral) with a carrier electrolyte with the additive of interest present. The additive is present from the beginning of the test or dosed into solution and the change in mass is tracked as a function of frequency. Still further or instead, determining whether the additive 258 is accumulable on the metal-containing active material may include goniometry, measurement of the contact angle of water on a surface, on the metal of interest and a baseline measurement is collected. The metal substrate is then soaked in an additive-containing solution and, after drying, the measurement is taken again. The resultant higher contact angle is indicative of hydrophobic organic compounds accumulating on the surface of the metal substrate.

In certain implementations, the additive 258 may interfere with redox chemistry of the one or more surfaces of the metal active material of the first electrode 251 without poisoning the first electrode 251. Further, or instead, stabilization of cations of the metal-containing active material with the additive 258 may be greater than stabilization of cations of the metal-containing active material with hydroxide ligands.

In some implementations, the additive 258 may include a complexing agent of one or more electrochemical dissolution products of the metal-containing active material in water. For example, the complexing agent may be a complexing agent of iron cations.

In certain implementations, the additive 258 may have low solubility in water. For example, the additive 258 may have a solubility of less than about 30 g/L in water at 1 atm pressure and 25° C. For example, the additive 258 may be substantially insoluble in water such that the additive 258 has a solubility of less than about 0.1 g/L in water at 1 atm pressure and 25° C.

In general, the suspension of the additive 258 in the gel 256 may be stable for at least 48 hours at 25° C. and 1 atm pressure, as may be useful for remaining robust during periods of rest of the electrochemical cell 250. As used in this context, stable suspension of the additive 258 in the gel 256 shall be understood to refer to no visually observable separation of the suspension into more than one phase.

In some implementations, the gel 256 may be alkaline. For example, the gel 256 may include potassium hydroxide (KOH). Further, or instead, the gel 256 may include water as the liquid medium 262. In some instances, the gel 256 may include a thickener. The thickener may be about 0.1 to about 10 wt % in the gel 256. In some instances, the thickener may include acrylate crosspolymer. As an example, the gel 256 may include acrylates/C10-30 alkyl acrylate crosspolymer.

In certain implementations, the polymer network 260 may be between 0.01 to 10 wt % in the gel 256. For example, the polymer network 260 may be 0.05 or greater and 0.5 or less wt % in the gel. Further, or instead, the polymer network 260 may include a cross-linked polyacrylic acid homopolymer.

In general, the additive 258 may be include any one or more of various different types of materials useful for improving performance of the electrochemical cell 250 relative to an electrochemical cell that is otherwise identical to the electrochemical cell 250 but does not include the additive 258. In certain instances, the additive 258 may include a molecule having a polar head and a nonpolar tail, an L-type ligand, and/or a sulfur atom. In some instances, the additive 258 may include a thiol functional group. For example, the additive 258 may be an alkane thiol, such as pentanethiol, butanethiol, hexanethiol, heptanethiol, and/or octanethiol. As a specific example, the additive may include an alkane thiol in a concentration of 100 ppm or greater to 2000 ppm or less in the gel 256. In some instances, the additive 258 may include polyethylene glycol (PEG). Further, or instead, the additive 258 may include alkylbenzensulfonic acid. Still further, or instead, the additive 258 may include at least one organic solvent. The at least one organic solvent may include dimethylacetamide (DMA), dimethoxyethane (DME), N-methylpyrrolidone (NMP), or any combination thereof.

In certain implementations, the additive 258 may include carboxylates, ethoxylates, sulfonates, ureas, thioureas, amines, amides, fluorinated compounds, or combinations thereof. Further, or instead, the additive 258 may include an electron rich component. Still further, or instead, the additive 258 may include phenanthroline.

In some implementations, the additive 258 may include a surfactant. The surfactant may form a layer on the surface of the metal-containing active material of the first electrode 251 to prevent or reduce water accessibility to the surface. Further, or instead, the surfactant may modify ease of accessing discharge and/or charge products of the first electrode 251. Still further, or instead, the surfactant may decrease iron reduction overpotential. The surfactant may include a charge-diffuse functional group and/or a combination of polar and non-polar portions that assist with changing the nature of the discharge and charge product. Compounds with a variety of functional groups (carboxylated, ethoxylates, sulfonates, amines, fluorocompounds, etc. as complex organics) may be used as a surfactant in the additive 258. As an example, the surfactant may include oxazoline (e.g., Alkaterge™ and/or Alkaterge T-IV, each available from Advancion of Buffalo Grove, Illinois, United States).

In some instances, the surfactant may include an amphoteric. Examples of a surfactant including an amphoteric include CHEMGUARD® S-111 (available from Chemguard of Mansfield, Texas, United States), CHEMGUARD® S-500 (available from Chemguard of Mansfield, Texas, United States), CAPSTONE® FS-50 (available from The Chemours Company of Newark, Delaware, United States), CAPSTONE®FS-51 (available from The Chemours Company of Newark, Delaware, United States), Zonyl® FSK (available from BOC Sciences of Shirley, New York, United States) m Zonyl® FS-500 (available from BOC Sciences of Shirley, New York, United States), DYNAX DX3001 (available from Dynax Corporation of Pound Ridge, New York, United States), APFS-14 (available from Advanced Polymer, Inc. of Carlstadt, New Jersey, United States), and MAFO (available from BASF of Florham Park, New Jersey, United States).

In some implementations, the surfactant may be anionic. For example, the surfactant may be Crodafos™ T5A (available from Croda of East Yorkshire, United Kingdom), Calfax® 6LA-70 (available from Pilot Chemical Company of Cincinnati, OH, United States), and Rhodafac RM 510 (available from Solvay USA Inc., NOVECARE of Princeton, New Jersey, United States).

In certain implementations, the surfactant may be nonionic. For example, the surfactant may be Igepal® CA-630 (available from Sigma-Aldrich, Inc. of St. Louis, MO, United States).

In some implementations, the additive 258 may include a sulfonated organic. Further, or instead, the additive 258 may include a sulfonated polymorph. Still further, or instead, the additive 258 may include a long-chain fatty acid. For example, the long-chain fatty acid may include carboxylate functional groups, phosphate functional groups, amine functional groups, or azo functional groups.

### Experimental Results for Electrolytes Including Additive Suspended in Gel

The following experiments demonstrate certain aspects of additives suspended in gel, as described herein for use in electrochemical cells having an anode with a metal-containing active material. It is to be understood that these experiments and corresponding results are set forth by way of example only, and nothing in these examples shall be construed as a limitation on the overall scope of this disclosure.

Gelled electrolyte was made with Carbopol ETD 2050 polymer (available from the Lubrizol Corporation of Wickliffe, Ohio, United States). Concentrations (Carbopol ETD 2050 polymer/total grams of solution) of 0.0625 wt %, 0.125 wt %, 0.25 wt %, and 0.5 wt % were made. The gel having 0.5 wt % of Carbopol ETD 2050 polymer was too gelled and caused the electrochemical cell to foam. The gels with 0.0625-0.25 wt % did not exhibit this foaming issue.

A gel formulation procedure was carried out. The desired wt % and volume of the gel were determined, and the amount of water and polymer needed were calculated. It is generally useful to target 4 wt % of the polymer so that dilution is possible later. Th amount of water needed was placed in a beaker, and the amount of polymer needed was placed in a boat. The beaker of water was set under an overhead stirrer and set stirring at slow speed (100 rpm). A powder of the polymer was slowly added to the water. After al of the polymer was added, the mixture was covered and stirred for 4 hours until homogeneous. The solution at this point is referred to as “pre-gel” and is not caustic. The amount of pre-gel, water, and potassium hydroxide (KOH) necessary to achieve the desired final wt % was calculated. Water, KOH solution, and pre-gel were added in that order to a beaker, and the contents were mixed under an overhead mixer and blended for 1 minute. The physical properties of the gelled electrolytes prepared for these experiments is listed in Table 1.

TABLE 1
Physical properties of gelled electrolytes.

| | | Viscosity | Density |
|---|---|---|---|
| Solution | Conductivity | (cP) | (g/mL) |
| Control Electrolyte | 618.53 at 26° C. | 1.9 | 1.286 at 20.7° C. |
| uncycled | | | |
| 0.0625%, uncycled | 624.70 at 20° C. | 2.6 | 1.288 at 20.6° C. |
| 0.125%, uncycled | 620 at 21° C. | 2.8 | 1.288 at 21.2° C. |
| 0.25%, cycled | 563.7 at 18° C. | — | — |
| 0.125%, cycled | 560.8 at 18° C. | — | — |

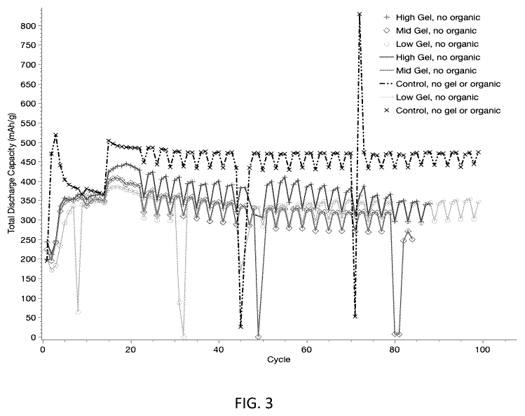

FIG. 3 is a graph of experimentally determined total discharge capacity (mAh/g) over a number of cycles for PEG electrochemical cells having electrolytes with the varying levels of gel in Table 1, without any additive. Based on these results, it may be appreciated that, without any additive, gels slow down conditioning and can lead to 50-100 mAh/g reduction in discharge capacity.

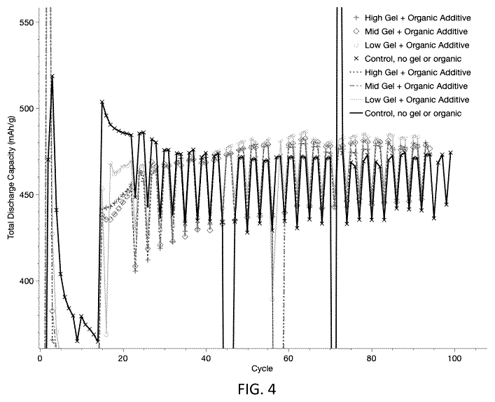

FIG. 4 is a graph of experimentally determined total discharge capacity (mAh/g) over a number of cycles for PEG electrochemical cells having electrolytes with an organic additive (pentanethiol) and varying levels of gel. For the last ten cycles (cycles 83-92) collected, the electrochemical cell with the 0.0625 wt % gel demonstrated 2% higher Coulombic efficiency than the control electrochemical cell, and the electrochemical cell with the 0.0625 wt % gel demonstrated slightly elevated energy efficiency comparted to the control electrochemical cell.

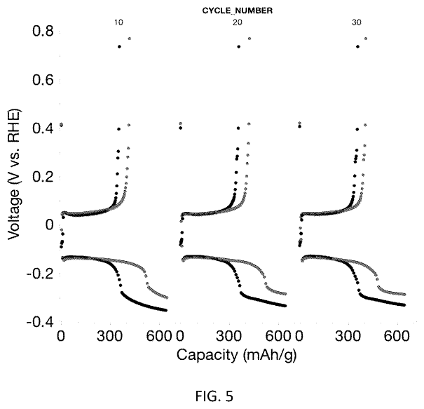

Experiments were performed with tapecast electrochemical cells. Each tapecast electrochemical cell included a reference electrode, a counter electrode (nickel mesh), and a working electrode (sintered iron anode). FIG. 5 is an experimentally determined graph of electrochemical cell voltage (versus reversible hydrogen electrode) as a function of capacity of a control tapecast electrochemical cell and of tapecast electrochemical cell including an electrolyte having an organic additive suspended in a gel. The tapecast electrochemical cell with the organic additive (pentanethiol) suspended in a gel demonstrated an 8% increase in Coulombic efficiency relative to the control tapecast electrochemical cell.

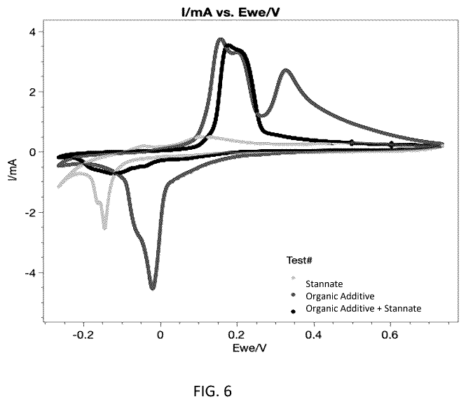

Cyclic voltammetry was performed for a number of different systems in which a planar iron foil acted as a simple model for porous iron batteries. FIG. 6 is an experimentally determined cyclic voltammetry graph of iron foil testing for a system including an electrolyte with including stannate and a gel without an additive, a system including an electrolyte with an organic additive suspended in gel and without stannate, and a system including an electrolyte with stannate and an organic additive suspended in stannate. As may be appreciated from these results, the use of a gel without an additive (lighter data series) does not prevent hydrogen evolution reaction (HER) while the use of a gel with an organic additive (pentanethiol) reduced the amount of HER occurring (two darker data series).

### Iron-Binding Ligands

Having described electrolytes including additives suspended in gel, attention is now directed to aspects of electrolyte additives including iron-binding ligands to improve performance of electrochemical cells including iron anodes. In general, passivation of the surface of an iron electrode may limit the accessible capacity of the iron electrode. For example, passivation of the surface of the iron electrode may lead to increase in overpotential (a decrease in voltaic efficiency) and/or loss of capacity over lifetime of the electrochemical cell.

Referring again to FIG. 1A, the negative electrode 14 (also referred to herein as the first electrode) may include an iron-containing active material (e.g., any one or more of the various different iron-containing active materials described herein) such that the rechargeable battery 10 (also referred to herein as an electrochemical cell) is an iron battery. Further, or instead, the positive electrode 12 may be an air electrode such that the rechargeable battery 10 is an iron-air battery. The electrolyte 20 may be an alkaline electrolyte in ionic communication between the negative electrode 14 and the positive electrode 12 (also referred to herein as the second electrode) and in contact with one or more surface of the iron-containing active material of negative electrode 102.

The electrolyte 20 may include an additive and, at least on discharge of the rechargeable battery 10, the additive may include an iron-binding ligand (e.g., an L-type ligand) formable into a coordination complex with one or more dissolution products of the negative electrode 14 on discharge of the rechargeable battery 10. As compared to an electrolyte without an iron-binding ligand, the iron-binding ligand in the electrolyte 20, at least on discharge of the rechargeable battery 10, may delay passivation of the surface of the iron-containing active material of the negative electrode 14 in contact with the electrolyte 20. For example, the iron-binding ligand may be a complexing agent the dissolution products (Fe3+ or Fe2+ compounds) of the iron-containing active material of the negative electrode 14. Further, or instead, the iron-binding ligands that do a better job of stabilizing the iron cation than a hydroxide ligand may delay the precipitation of iron oxide back onto the surface of the iron-containing active material of the negative electrode 14, facilitating accessing more discharge capacity. Additives engageable in this mechanism of action, at least on discharge of the rechargeable battery 10, may be capable of multi- or bidentate coordination, may be electron rich and, further or instead, may span a wide range of functional groups including one or more of alcohols, thiols, amines, amides, carbonyl, carbamates, or thioureas. As an example, the additive may include: phenanthroline, triethanolamine, sulfosalicylic acid, pentahydroxyflavone, sodium diethyldithiocarbamate, Ethylenediaminetetraacetic acid (EDTA)-like compounds including hydroxyethylethylenediaminetriacetic acid (HEDTA) and hydroxyethylidene diphosphonic acid (HEDP), lignin compounds, sulfonates, or a combination thereof. Further, or instead, the iron-binding ligand may include a long-chain fatty acid. Still further, or instead, the iron-binding ligand may include polyethylene glycol (PEG). Additionally, or alternatively, the additive may include one or more organic molecules.

In certain implementations, the additive may include a surfactant. For example, the surfactant may include oxazoline (e.g., Alkaterge™ and/or Alkaterge T-IV, each available from Advancion of Buffalo Grove, Illinois, United States).

In some implementations, the iron-binding ligand may include one or more acids. For example, the additive may include citric acid, succinic acid, malic acid, malonic acid, sodium 3-hydroxybutyrate, or a combination thereof.

In certain implementations, the iron-binding ligand may include a deprotonated carboxylic group.

In some implementations, the additive may include water, such as may be useful for supporting the iron-binding ligand.

In certain implementations, the additive may include acrylate polymer.

In some implementations, the electrolyte 20 may further include a gel. The gel may be any one or more of the various different types of gels described herein with respect to FIG. 2 and, for the sake of clear and efficient description, the various aspects of suspension of an additive in gel described with respect to FIG. 2 are not repeated here, but should nevertheless be understood to be applicable to suspending an additive including an iron-binding ligand, unless otherwise specified or made clear from the context. Thus, for example, the additive may be suspended in the gel, and the gel may be contact with one or more surfaces of the iron-containing active material of the negative electrode 14. Further, or instead, the negative electrode 14 may be in ionic communication with the positive electrode 12 electrode via the gel.

### Experimental Results for Iron-Binding Ligands

The following experiments demonstrate certain aspects of iron-binding ligands as additives, as described herein for use in electrochemical cells having an anode with metal-containing active material. It is to be understood that these experiments and corresponding results are set forth by way of example only, and nothing in these examples shall be construed as a limitation on the overall scope of this disclosure.

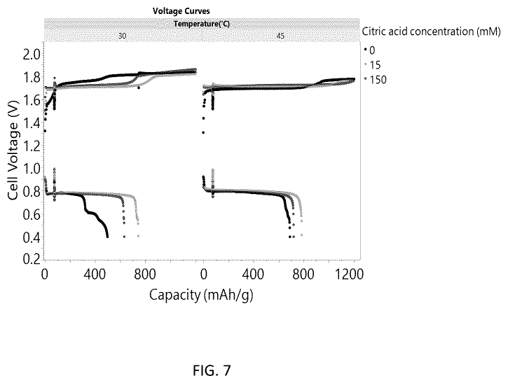

FIG. 7 is an experimentally determined graph of electrochemical cell voltage as a function of capacity comparing electrochemical cells including electrolytes with different concentrations of citric acid. As may be appreciated from these tests, increasing concentration of citric acid in the electrolyte increased performance (less overpotential and access to more capacity).

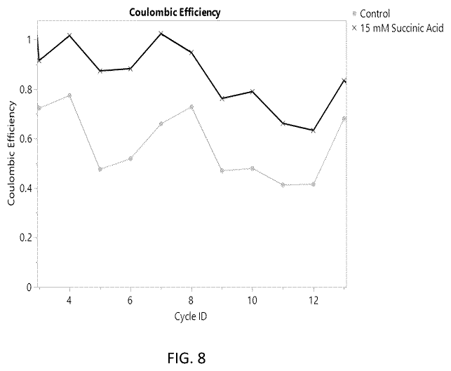

FIG. 8 is an experimentally determined graph of Coulombic efficiency as a function of number of cycles for a baseline PEG electrochemical cell without an additive and a test PEG electrochemical cell having an electrolyte including succinic acid. These tests demonstrated that succinic acid significantly increased Coulombic efficiency compared t the baseline PEG electrochemical cell.

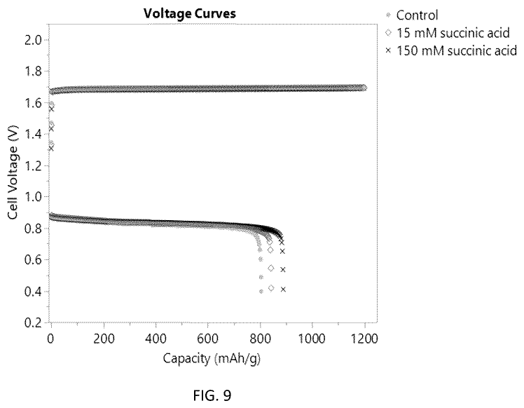

FIG. 9 is an experimentally determined graph of electrochemical cell voltage as a function of capacity comparing electrochemical cells including electrolytes with different concentrations of succinic acid. These tests demonstrated that the succinic acid additive resulted in access to more discharge capacity.

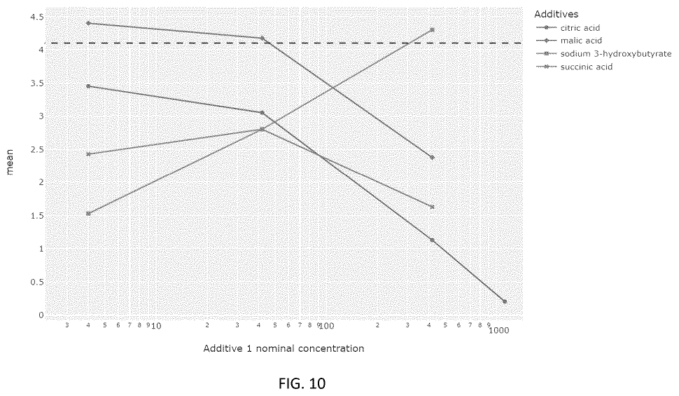

FIG. 10 is an experimentally determined graph of ex situ hydrogen screening for citric acid, malic acid, sodium 3-hydroxybutyrate, and succinic acid. For these tests, baseline electrolyte and iron were sealed in a control vial without an additive (dashed line in the figure), and a respective test vial was prepared for each additive. The displacement of a plunger of an empty syringed was used to measure the volume of hydrogen evolved from each vial after 18 hours of incubation at 65° C. These results showed that lower concentrations of malic acid were useful for reducing hydrogen production while higher concentrations of hydroxybuyrate were helpful at higher concentrations.

The foregoing method descriptions are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not necessarily intended to limit the order of the steps; these words may be used to guide the reader through the description of the methods. Further, any reference to claim elements in the singular, for example, using the articles “a,” “an” or “the” is not to be construed as limiting the element to the singular.

The preceding description of the disclosed embodiments is provided to enable any person skilled in the art to make or use the described embodiment. Further, any step of any embodiment described herein can be used in any other embodiment. Various modifications to these embodiments will be readily apparent to those skilled in the art, and the generic principles defined herein may be applied to other embodiments without departing from the scope of the disclosure. Thus, the present disclosure is not intended to be limited to the embodiments shown herein but is to be accorded the widest scope consistent with the following claims and the principles and novel features disclosed herein.

What is claimed is:

1. An electrochemical cell comprising:
a first electrode including a metal-containing active material;
a second electrode; and
an electrolyte in ionic communication between the first electrode and the second electrode, the electrolyte including a gel and an additive, the gel including a polymer network and a liquid medium, the polymer network carried in the liquid medium, the additive suspended in the gel and accumulable at the metal-containing active material of the first electrode.

2. The electrochemical cell of claim 1, wherein the gel is in contact with the second electrode.

3. The electrochemical cell of claim 1, wherein the additive interferes with redox chemistry of the one or more surfaces of the metal-containing active material of the first electrode without poisoning the first electrode.

4. The electrochemical cell of claim 1, wherein stabilization of cations of the metal-containing active material with the additive is greater than stabilization of cations of the metal-containing active material with hydroxide ligands.

5. The electrochemical cell of claim 1, wherein the metal-containing active material is iron.

6. The electrochemical cell of claim 1, wherein the second electrode is an air electrode.

7. The electrochemical cell of claim 1, wherein the additive includes a complexing agent of one or more electrochemical dissolution products of the metal-containing active material in water.

8. The electrochemical cell of claim 1, wherein the additive has a solubility of less than about 30 g/L in water at 1 atm pressure and 25° C.

9. The electrochemical cell of claim 1, wherein the polymer network is between 0.01 to 10 wt % in the gel.

10. The electrochemical cell of claim 1, wherein the additive includes an L-type ligand.

11. An electrochemical cell comprising:
a first electrode including an iron-containing active material;
a second electrode; and
an alkaline electrolyte in ionic communication between the first electrode and the second electrode, the alkaline electrolyte in contact with one or more surfaces of the iron-containing active material of the first electrode, the alkaline electrolyte including an additive and, at least on discharge of the electrochemical cell, the additive including an iron-binding ligand formable into a coordination complex with one or more dissolution products of the first electrode on discharge of the electrochemical cell.

12. The electrochemical cell of claim 11, wherein the iron-binding ligand is a complexing agent of iron cations.

13. The electrochemical cell of claim 11, wherein the iron-binding ligand includes a multi-dentate component or a bi-dentate component.

14. The electrochemical cell of claim 11, wherein stabilization of cations of the iron with the additive is greater than stabilization of cations of the iron with hydroxide ligands.

15. The electrochemical cell of claim 11, wherein the iron-binding ligand includes an L-type ligand.

16. The electrochemical cell of claim 11, wherein the iron-binding ligand includes a long-chain fatty acid.

17. The electrochemical cell of claim 11, wherein the iron-binding ligand includes polyethylene glycol (PEG).

18. The electrochemical cell of claim 11, wherein the additive includes one or more organic molecules.

19. The electrochemical cell of claim 11, wherein the additive includes a surfactant.
